(19) United States
(12) Patent Application Publication
(10) Pub. No.: US 2011/0029262 A1
(43) Pub. Date: Feb. 3, 2011

(54) CONTAINER LEVEL SENSOR ASSEMBLY

(75) Inventor: Sydney BARKHOUSE, Oakville (CA)

Correspondence Address: OGILVY RENAULT LLP, 1, Place Ville Marie, SUITE 2500, MONTREAL, QC, H3B 1R1, CA

(73) Assignee: WOLFEDALE ENGINEERING LIMITED, Brampton (CA)

(21) Appl. No.: 12/846,330

(22) Filed: Jul. 29, 2010

Related U.S. Application Data
(60) Provisional application No. 61/229,666, filed on Jul. 29, 2009.
(60) Provisional application No. 61/296,531, filed on Jan. 20, 2010.

(51) Int. Cl. G01F 23/00

(52) U.S. Cl. 702/55

(57) ABSTRACT

A container level sensor assembly for sensing level of liquid remaining in a container.

### CROSS-REFERENCE TO RELATED APPLICATION

The present disclosure claims priority from U.S. provisional patent application No. 61/229,666, filed Jul. 29, 2009, and from U.S. provisional application No. 61/296,531, filed Jan. 20, 2010 the entireties of which are hereby incorporated by reference.

### FIELD OF TECHNOLOGY

The present disclosure is related to container level sensor assemblies, in particular container lever sensor assemblies suitable for use with a gas tank of a barbeque.

### BACKGROUND

Conventional gas barbeques may have liquid fuel (e.g., liquid propane) stored in a container (e.g., a gas tank). The amount of gas remaining in the container may affect the amount of cooking time available. The amount of fuel remaining in the container may be hard to determine, since the container may be opaque and weighing the container while the barbeque is in use may not be practical and/or possible. It may be desirable to provide a sensor for determining the level of liquid remaining in the container.

### SUMMARY

In some aspects, there is provided a container level sensor assembly comprising: a level sensor for measuring a level of a liquid in a container; a contact layer between a sensing surface of the level sensor and the container for maintaining a close contact between the level sensor and the container; a biasing member for biasing the level sensor towards the container; a container ring configured to accommodate the level sensor, the container ring also being configured to support a base of the container; the container ring having a magnetic member for bringing the container ring into close contact with the base of the container; a controller including a processor for receiving measurement data from the level sensor and determining a remaining availability of liquid in the container based on the measured level of the liquid; and a display device for displaying the determined remaining availability of liquid in the container.

In some aspects, there is provided a container level sensor assembly comprising: a level sensor for measuring a level of a liquid in a container; a contact layer between a sensing surface of the level sensor and the container for maintaining a close contact between the level sensor and the container; a biasing member for biasing the level sensor towards the container; a retainer configured to accommodate the level sensor; and the retainer having a magnetic member for bringing the level sensor into close contact with the container.

In some aspects, there is provided a container level sensor assembly comprising: a level sensor for measuring a level of a liquid in a container; a retainer configured to accommodate the level sensor; the retainer having a magnetic member for bringing the level sensor into close contact with the container; a controller including a processor for receiving measurement data from the level sensor and determining a remaining availability of liquid in the container based on the measured level of the liquid; and a display device for displaying the determined remaining availability of liquid in the container.

### BRIEF DESCRIPTION OF THE DRAWINGS

FIG. 1 shows an exploded view of an example embodiment of a container level sensor assembly;

FIG. 2 shows the container level sensor assembly of FIG. 1 in various views;

FIG. 3 shows a cutaway side view along line B-B, and top and isometric views of an example container level sensor assembly, in a disengaged position;

FIG. 4 shows a cutaway side view along line B-B, and top and isometric views of the example container level sensor assembly of FIG. 3, in an engaged position;

FIG. 5 shows top and isometric view of an example level sensor in an example container level sensor assembly;

FIG. 6 shows a cutaway side view along line B-B, and top and isometric views of an example sensor plunger in an example container level sensor assembly;

FIG. 7 shows a cutaway side view along line B-B, and top and isometric views of an example magnet retainer in an example container level sensor assembly;

FIG. 8 shows a cutaway side view along line B-B, and top and isometric views of an example container ring in an example container level sensor assembly;

FIG. 9 shows side, top and isometric view of an example container level sensor assembly;

FIG. 10 shows a cutaway side view along line A-A, and top and isometric views of an example container level sensor assembly, in a disengaged position;

FIG. 11 shows a cutaway side view along line A-A, and top and isometric views of the example container level sensor assembly of FIG. 10, in an engaged position;

FIG. 12 shows isometric and front views of an example container level assembly incorporating an example controller, mounted on a gas tank;

FIG. 13 shows isometric and side views of the container level sensor assembly of FIG. 12, mounted on a gas tank;

FIG. 14 shows top isometric and bottom isometric views of the container level sensor assembly of FIG. 12;

FIG. 15 shows an isometric view of the container level sensor assembly of FIG. 5;

FIG. 16 shows top and isometric views of the container level sensor assembly of FIG. 5;

FIG. 17 shows top and isometric views of another example container level sensor assembly;

FIG. 18 shows an isometric view and an exploded isometric view of an example controller suitable for an example container level sensor assembly;

FIG. 19 shows front, side and isometric views of the controller of FIG. 18;

FIG. 20 shows bottom, isometric, front and side views of the controller of FIG. 18 in a self-standing configuration;

FIG. 21 shows front, side and isometric views of another example controller suitable for an example container level sensor assembly;

FIG. 22 shows bottom, isometric, front and side views of the controller of FIG. 21 in a self-standing configuration;

FIG. 23 shows front, side and isometric views of another example controller suitable for an example container level sensor assembly;

FIG. 24 shows an example input mechanism suitable for an example controller;

FIG. 25 shows another example input mechanism suitable for an example controller;

FIG. 26A illustrates an example operation of an example container level sensor assembly having an example controller;

FIG. 26B illustrates another example operation of an example container level sensor assembly having an example controller;

FIG. 27A illustrates an example controller suitable for an example container level sensor assembly; and

FIG. 27B illustrates another example controller suitable for an example container level sensor assembly.

### DETAILED DESCRIPTION

Example embodiments of a container level sensor assembly are described. The container level sensor assembly may be used to measure the amount of liquid (e.g., a liquefied gas or fuel) in a container (e.g., a gas tank), for example using a level sensor. The container level sensor assembly may include a controller having a processor for receiving measurements from a level sensor (and a flow sensor, where appropriate) and for calculating the remaining liquid in the container. The remaining liquid in the container may be calculated as one or more of: a remaining height of liquid in the container, a weight of remaining liquid in the container, and an estimating remaining available consumption time of the liquid in the container. This and other information may be presented to a user via, for example, a display which may be provided on the controller. The display may provide the information as, for example, text, images, icons, or combinations thereof. Other mechanisms for presenting information to the user may include, for example, audio devices (e.g., buzzer or speaker), gauges, and lights, among others. The controller may also include input mechanisms (e.g., input buttons, levers, dials, etc.) for selecting what and/or how information is provided, and/or for programming a function of the container level sensor assembly (e.g., a timer function, or a warning when fuel is low).

In addition to or alternative to providing information about the remaining liquid in the container, the container level sensor assembly may also be used to estimate the remaining available consumption time, for example cooking time for a barbeque, for example using a controller having a processor that makes calculations based on measurements from the level sensor. The container level sensor assembly may also be used to estimate (e.g., using a processor) the remaining available consumption time based on the level of liquid in the container, as sensed by the level sensor. In some examples, the consumption rate (e.g., based on a flow rate as sensed by a flow sensor) may additionally be used to calculated the remaining available consumption time.

In some examples, the container level sensor assembly may be used with a gas tank of a barbeque. In such a case, the flame setting of the barbeque may be taken into account in example calculations. For example, when the barbeque is on a low flame, the consumption rate out of fuel may be lower and the estimated remaining available consumption time may be higher for a given container level. The lower consumption rate when the barbeque is on a low flame may be determined based on the flow rate of fuel from the container (e.g., as measured using a flow sensor) and/or may be determined based on an estimated consumption rate associated with the flame setting (e.g., a known flow rate of fuel may be defined for a given flame setting).

An example embodiment of the container level sensor assembly will now be described. In some examples, the container level sensor assembly may include any suitable level sensor, for example the level sensor described in PCT/CA2007/002085, which publication is hereby incorporated by reference in its entirety.

In some examples, the level sensor may be sensor for sensing the level of liquid (e.g., a liquid fuel) within the container, using a sonar-type technology, for example, UART 19.2K. Another example of a suitable sensor level is described in Canadian Patent No. 2,644,410, which publication is hereby incorporated by reference in its entirety. For such sonar-type sensors, it may be desirable to ensure that the sensor is in close contact with the container, in order to help ensure a relatively accurate and/or reliable reading. While the weight of the container may be sufficient to press the container against a sensor positioned beneath the base of the container, it may be useful to also to provide a force pressing the sensor against the base of the container, for example to account for situations where the container may be shifted in position and/or where the container base is rounded, uneven or otherwise difficult to press against the sensor surface.

Other sensor types may be used for sensing the level of liquid in the container including, for example, a force sensor or a pressure sensor that may measure the weight of the remaining liquid in the container.

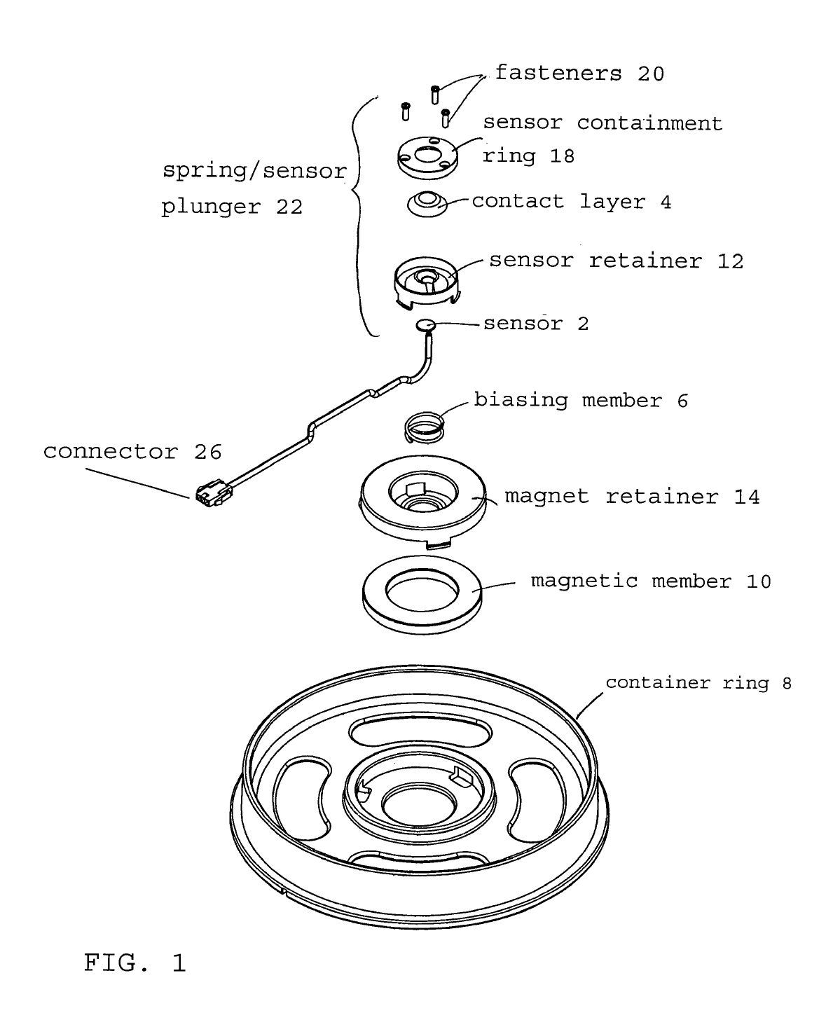

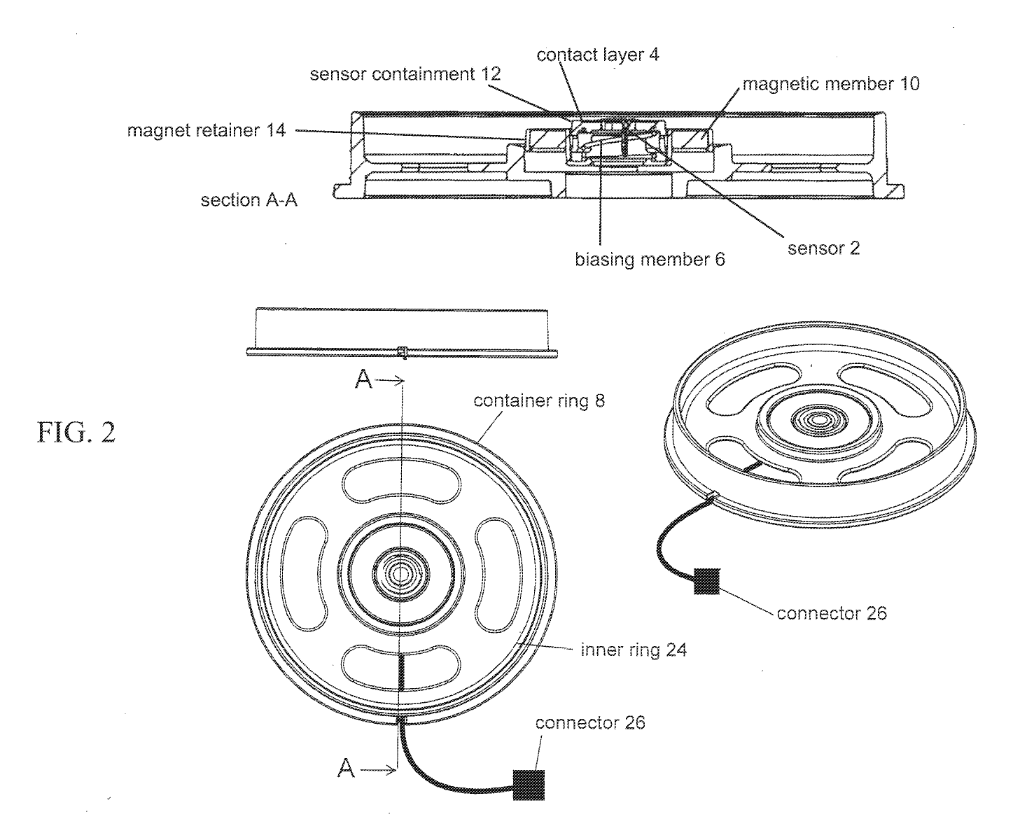

FIG. 1 shows an exploded view of an example container level sensor assembly. FIG. 2 shows the example container level sensor assembly in a top view, a side view, and an isometric view. In this example, the container level sensor assembly may include a level sensor 2, a contact layer 4, a biasing member 6, a container ring 8, and a magnetic member 10. The level sensor 6 may measure a level of a liquid in a container. The contact layer 4 may be positioned between a sensing surface of the level sensor 2 and the container for maintaining a close contact between the level sensor 2 and the container. The biasing member 6 (e.g., a spring, a biasing foam, or a resilient member) may bias the level sensor 2 towards the container. The container ring 8 may be configured to accommodate the level sensor 2 (e.g., in the center of the ring), and may also be configured to support a base of the container. The container ring 8 may have the magnetic member 10 (e.g., a ring magnet or a plurality of magnets arranged about the level sensor 2, such as in a ring formation) for bringing the container ring 8 into close contact with the base of the container. The level sensor 2 may be accommodated within the magnetic member 10, such that when the magnetic member 10 is attracted towards the base of the container, the level sensor 2 may be also pressed against the base of the container.

In some examples, the container level sensor assembly may also include a controller having a processor for determining a remaining availability of liquid in the container based on the measured level of the liquid. In some examples, the container level sensor assembly may also include a display device for displaying the determined remaining availability of liquid in the container. These will be described with reference to other figures.

A fuel container for a barbeque may be supported by a conventional support ring, which may provide some stability for the container. However, there may be no mechanism for holding the container in place on the ring, aside from gravity and/or friction. This may result in slipping and/or dislocation of the container from the support ring, which may be undesirable.

In the example embodiment of the container level sensor assembly of FIG. 1 and FIG. 2, a sensor retainer 12 houses the level sensor 2, and may be provided in the container ring 8. The container ring 8 may be placed directly underneath the container and/or inside any basepan or other support for the container. The container ring 8 can be designed to accommodate a variety of container sizes (e.g., 201b or 301b containers). Types of containers that may be used with the container level sensor assembly may include, for example, gas tanks suitable for a barbeque, such as liquid propane tanks suitable for a residential barbeque device, and other liquid containers. Although the level sensor 2 has been described as being provided in the container ring 8, in other examples, the level sensor 2 may be provided separately (e.g., a portable or pocket-sized version), which may be placed in a conventional container ring as desired, or may be used without a container ring.

In this example, the container level sensor assembly may be comprised of the following components: container ring 8, magnetic member 10, magnet retainer 14, biasing member 6, level sensor 2, and contact layer 4 (e.g., an adhesive contact cap). The container ring 8 may be sized to fit inside conventional basepans of different barbeques.

The container ring 8 may be provided with a slight lip (e.g., inner ring 24), allowing it to be a more stable container ring than conventional container rings. The container ring 8 may be provided with a protective layer on its bottom, so that it may be placed directly on a surface (e.g., the surface of a deck or patio) without the risk of scratching the surface, which may avoiding the need for any separate support or basepan for the container. The container ring 8 may include apertures or cutaways, for reducing the material used in the container ring. This may be useful for reducing the cost and the weight of the container ring 8, and/or for dispelling any fluid or unwanted matter from within the assembly. The apertures or cutaways may also be useful for assisting in the removal of the container ring 8 from the container, for example by providing a handhold for gripping the container ring.

The container level sensor assembly may include the container ring 8, or may not include the container ring 8 (e.g., where the assembly may be used alone or may be used with other conventional container supports or container rings/basepans). Where the assembly does not include the container ring 8, the magnetic member 10 may be provided, for example, in a magnet retainer 14 that may accommodate or house the level sensor 2. Where the container level sensor assembly includes the container ring 8, the level sensor 2 may be accommodated or housed by the container ring 8, which may help to avoid the level sensor 2 sticking to the container when the container is removed.

In this example, the level sensor 2, sensor retainer 12, contact layer 4, a sensor containment ring 18 and fasteners 20 may together be referred to as the spring/sensor plunger 22. Although the plunger 22 may be referred to as the spring/sensor plunger 22, the biasing member 6 may be any biasing member 6 including, for example, a spring, a biasing foam, or a resilient member, among others. In this example, the level sensor 2 may be provided inside the magnetic member 10, against the biasing member 6. The biasing member 6 may bias the level sensor 2 towards the container.

In some examples, the magnetic member 6 may be donut-shaped to accommodate the level sensor 2 in the middle. In other examples, the magnetic member 6 may include a plurality of magnets (e.g., three magnets, which may be relatively small, such as the size of a watch battery) fixed on a magnet support (e.g., a metal plate), which may be arranged about the level sensor 2. The one or more magnets may be arranged about the level sensor 2 in any suitable formation (e.g., ring formation, square formation, irregular formation, semicircular formation, etc.). The one or more magnets may be arranged in a formation sufficient to help ensure that the container is in good close contact with the level sensor 2. The use of a plurality of magnets may allow for better attachment to the container (e.g., where the container bottom is round or uneven), and/or a reduction in cost in manufacturing. The magnetic member 10 may serve as a mechanism for attaching the level sensor 2 to the bottom of the container and/or maintaining a close contact between the container ring 8 and/or level sensor 2 and the container. The use of the magnetic member 10 may serve to hold the level sensor 2 to the bottom of the container without having to rely solely on the weight of the container sitting on the level sensor 2.

The level sensor 2 may include a connector 26 for communicating with a controller, as will be described further below.

In operation, the container may be lifted directly above the container level sensor assembly and placed on top of the container ring 8. The magnetic member 10 may float freely and may pull itself towards the container securing the assembly into place. The spring/sensor plunger 22 may be biased (e.g., with a biasing member 6, such as a spring) and may push, with the level sensor 2 (e.g., a sonar transducer), against the bottom of the container into a secured resting position touching, in association with or in close contact with the container bottom.

In some examples, close contact between the level sensor 2 and the container surface may be useful for helping to ensure a reliable and/or accurate measurement from the level sensor 2. A good contact between the level sensor 2 and the container may be any close contact (e.g., with minimal or no gap over at least a majority of the contact or sensing surface of the sensor 2) sufficient to obtain a reliable and/or accurate steady measurement from the level sensor 2.

The force pressing the level sensor 2 against the container (e.g., as by the biasing member 10 and/or the magnetic member 10) may allow for close contact between the level sensor 2 and the container, even given any deviation on the container bottom. For example, the container may have a curved, flat, or uneven bottom. The magnetic member 10 and/or the biasing member 6 may help ensure that the level sensor 2 is pressed in close contact against the bottom of the container, regardless of whether the bottom is curved or flat or otherwise uneven, which may help to ensure a relatively accurate and/or reliable sensor measurement. The contact layer 4, such as a urethane layer or a metal layer (e.g., an aluminum layer), may further help to ensure that a close contact is maintained between the level sensor 2 and the container. The contact layer 4 may be provided on the contact or sensing surface of the level sensor 2, so that the contact layer 4 may ensure a close and/or relatively air-free contact between the level sensor 2 and the container bottom, which may help to ensure a relatively accurate and/or reliable sensor reading. The contact layer 4 may also be useful where the container surface has small rough areas that may other lead to air gaps in the contact between the level sensor 2 and the container. In some examples, the contact layer 4 may not be included, for example where the level sensor 2 itself is sufficiently flexible and/or is made of a material suitable to help ensure a good close contact is made with the container.

The container ring 8 may be configured to allow different container designs to be accommodated without any addition plastic rings or base supports. However, the container ring 8 may be nonetheless designed to fit inside any conventional base supports.

The container ring 8 may act as a housing for the container level sensor assembly as well as a way of locating the level sensor 2 concentrically onto the container. The container ring 8 may include a number of knockouts for the user to hold onto the ring 8 and/or to aid in both locating and removing from the container. In some examples, the level sensor 2 may be provided independent of the container ring 8. In some examples, the presence of the magnetic member 10 on the container ring 8 may also be useful for stabilizing the container on the container ring 8.

In some examples, the sensor retainer 12 may be provided, which may retain the level sensor 2 and the contact layer 4 within the plunger 22 (e.g., to avoid the sensor 2 and/or the contact layer 4 from being lifted off or sticking to the container when the container is removed from the container ring 8) and on the container ring 8. Although the sensor retainer 12 is shown with three fasteners 20 (e.g., screws), other methods may be suitable for coupling the sensor retainer 12 to the spring/sensor plunger 22. In other example embodiments, other sensor retention features may be employed, for example while ensuring that the contact layer 4 is retained while maintaining a positive contact between the level sensor 2 and the contact layer 4, which may permit sufficient engagement and location of the sensor 2 to the fuel container.

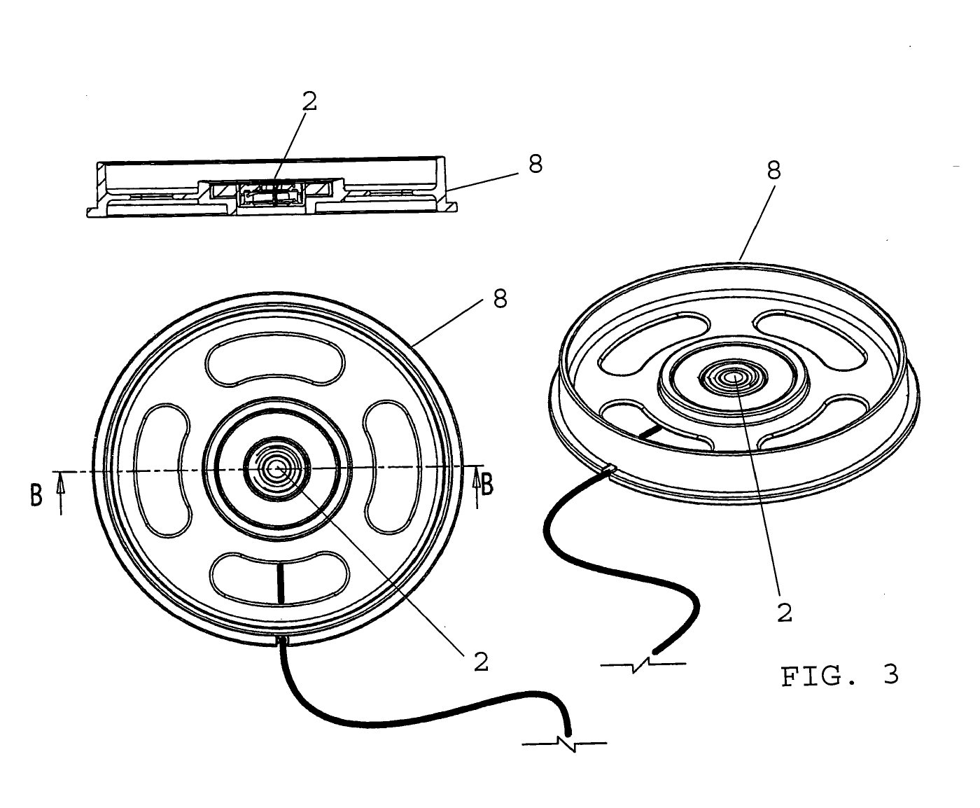

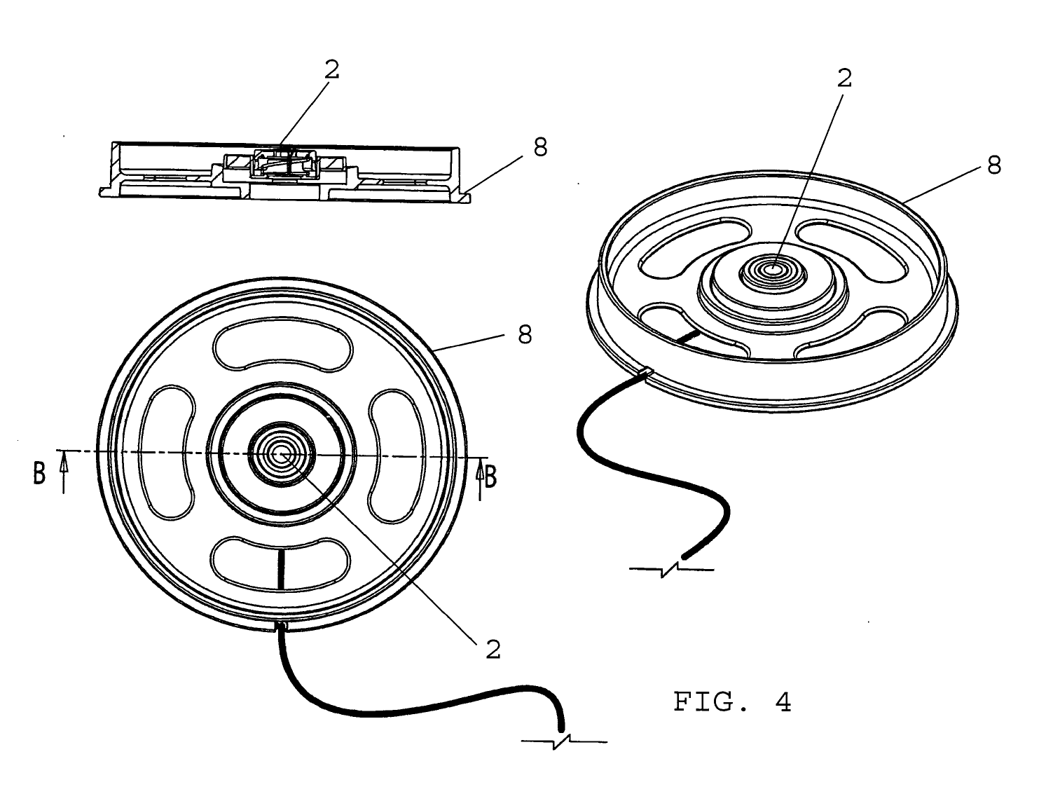

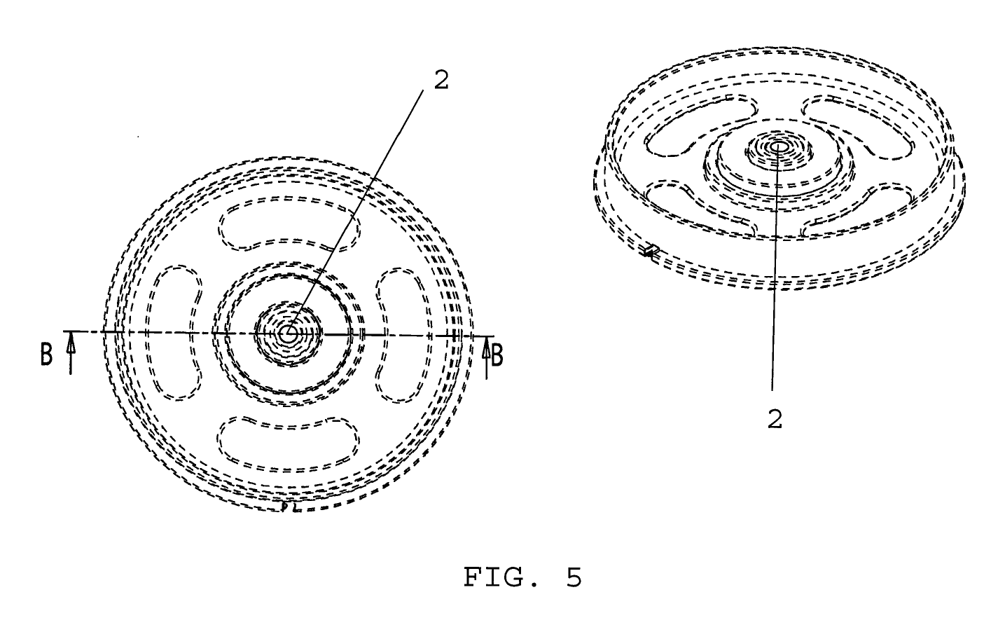

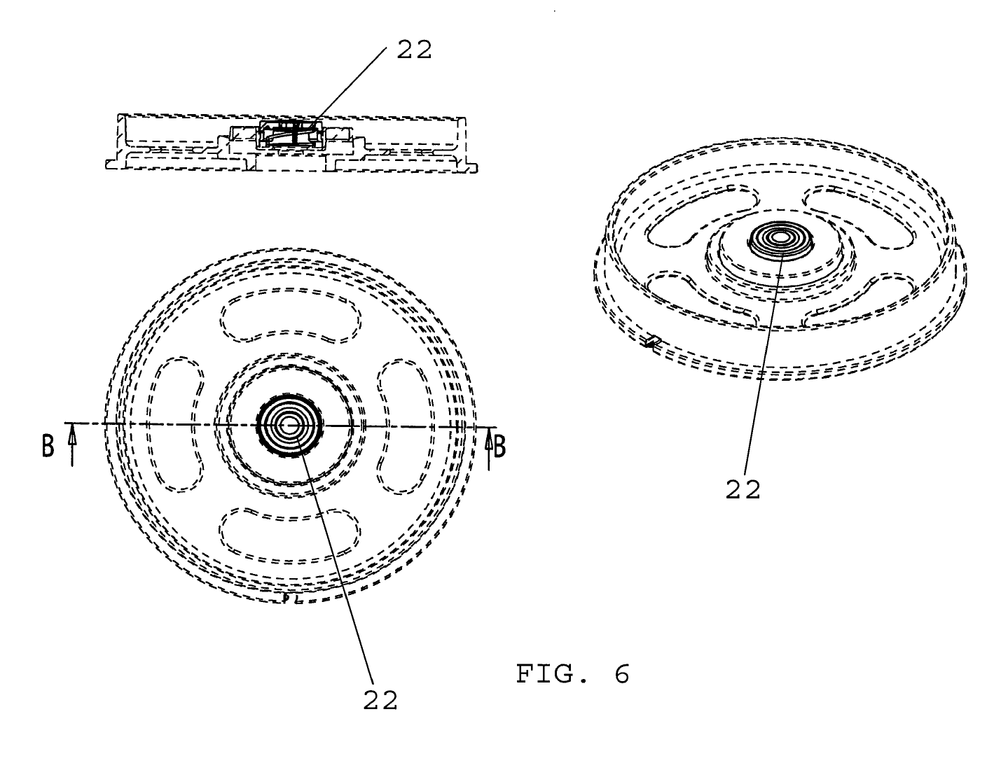

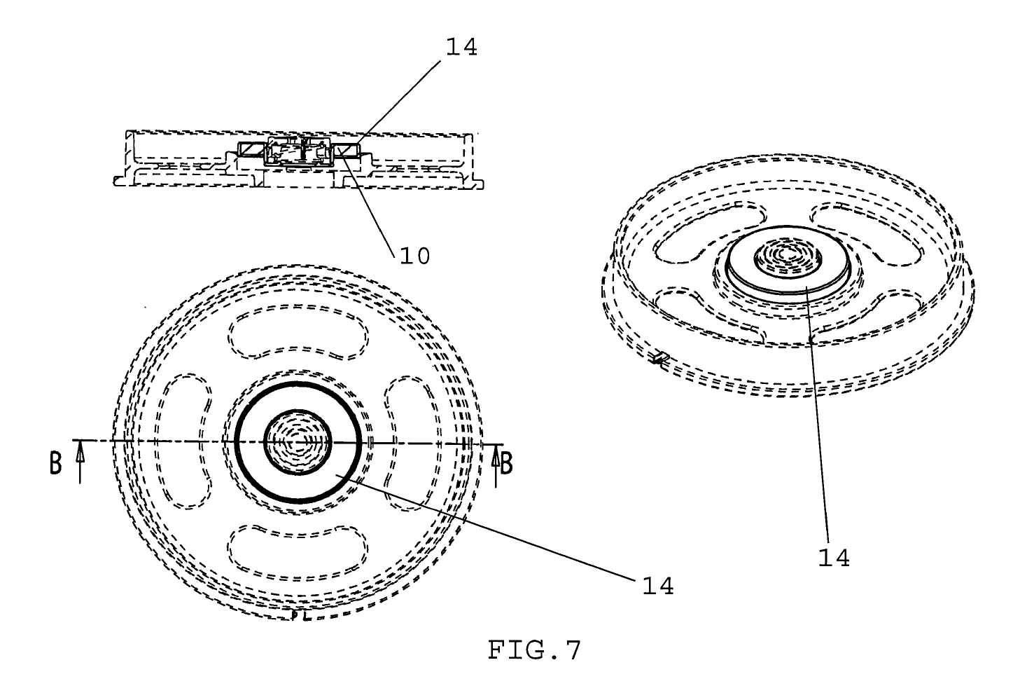

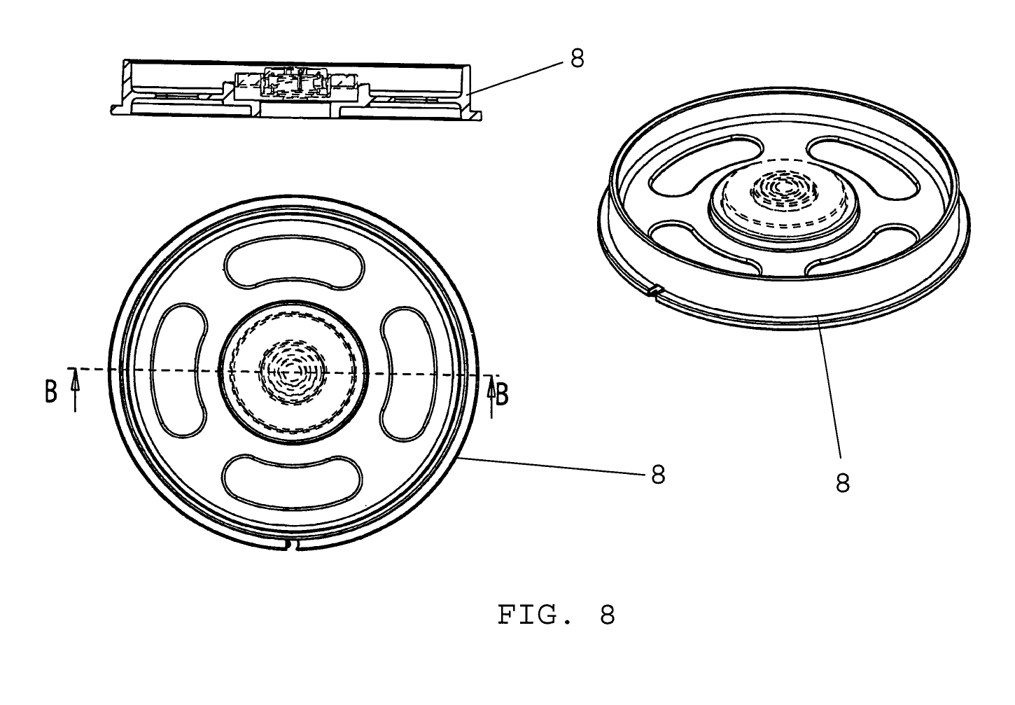

In the example shown in FIG. 3, the container ring 8 is shown in a disengaged position, where the magnetic member 10 is at rest. In the example shown in FIG. 4, the container ring 8 is shown in an engaged position, where the magnetic member 10 is lifted up towards the container (not shown). FIGS. 5-8 illustrate, in particular, examples of the level sensor 2, spring/sensor plunger 22, magnet retainer 14 and magnetic member 10, and container ring 8, respectively, within the container level sensor assembly.

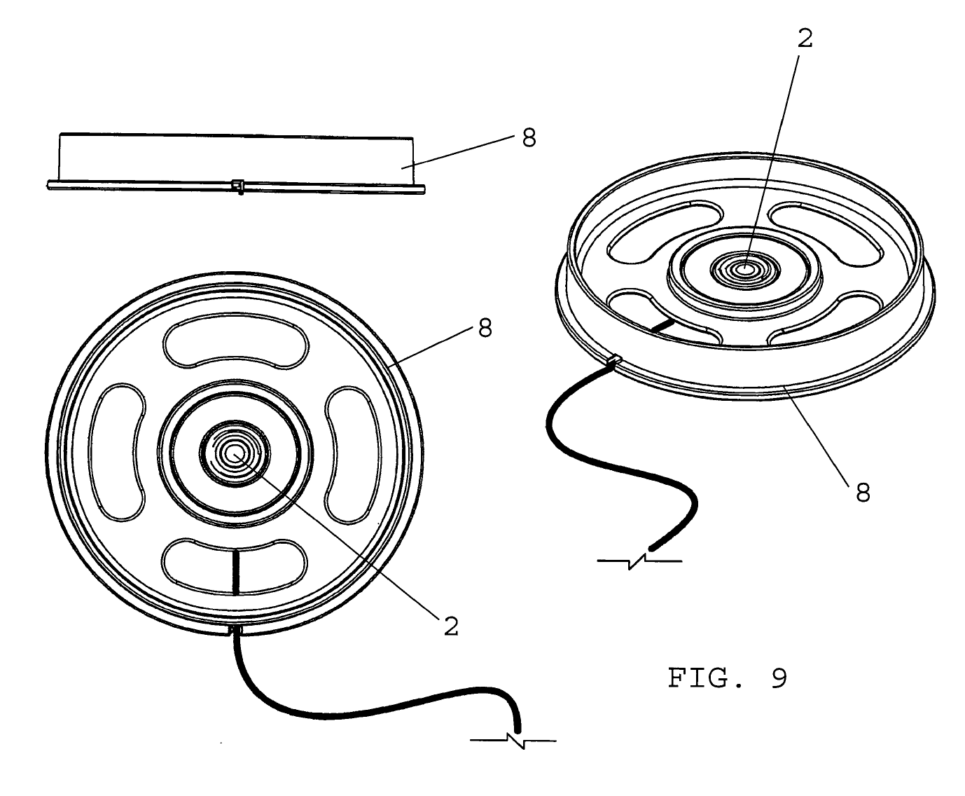

Another example container level sensor assembly is shown in FIGS. 9-11. The example container level sensor assembly of FIGS. 9-11 may be generally similar to the example container level sensor assembly described above.

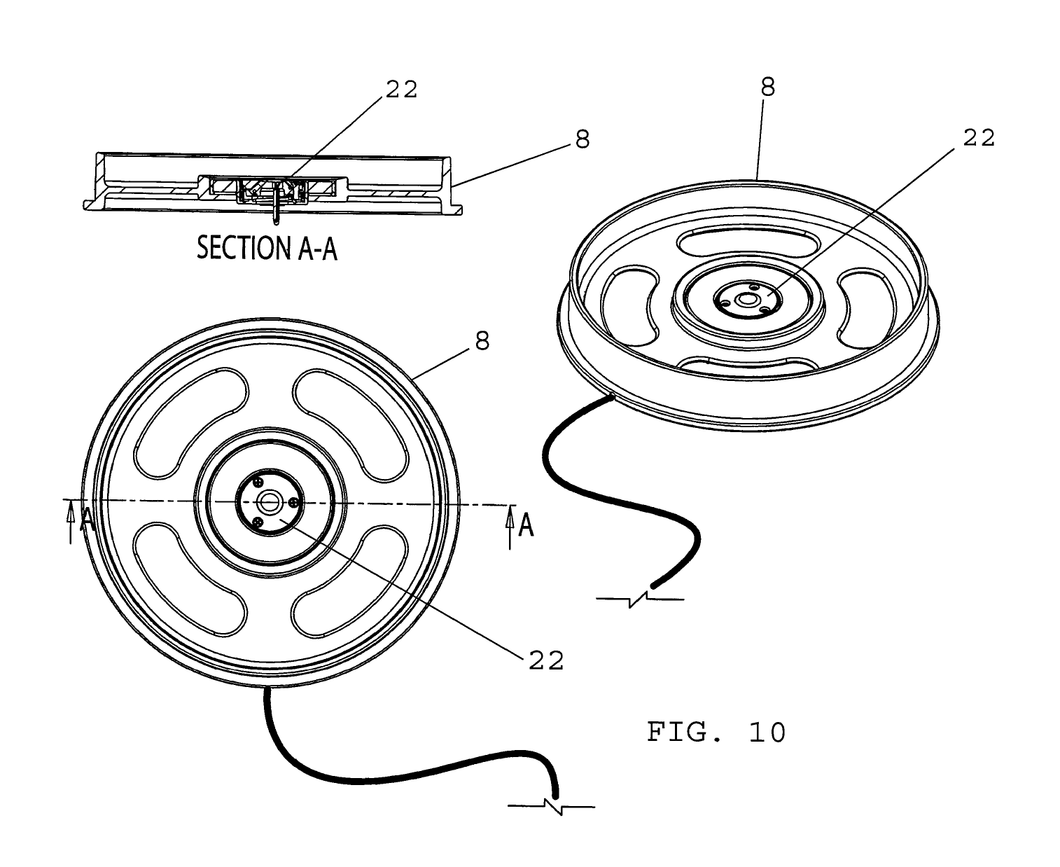

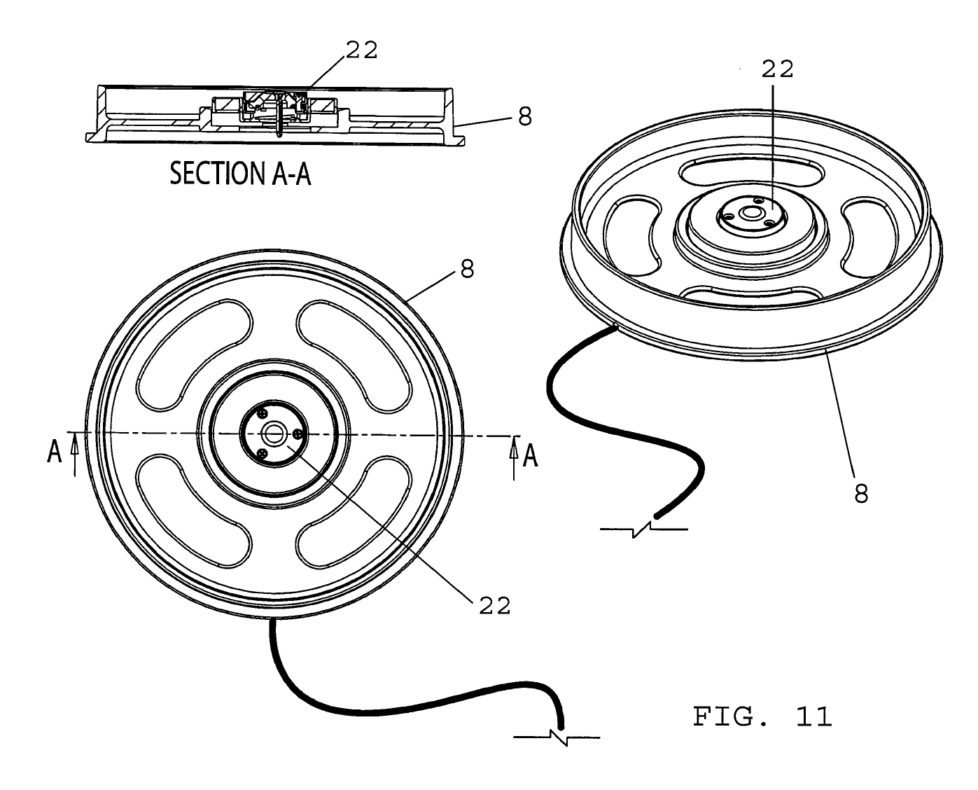

FIGS. 10 and 11 illustrate the container ring 8, including the sensor retainer 12, with the spring/sensor plunger 22 in the depressed (i.e., with a container (not shown) resting on top) and undepressed (i.e., without a container resting on top) positions, respectively.

In some examples, the container level sensor assembly may include a connector 26 for communication measurements from the level sensor 2 to the controller. In other examples, the connector 26 may not be used and instead wireless communication may be used for communication between the level sensor 2 and the controller.

In some examples, the container ring 8 may have an outer diameter of, for example, about 7 inches to about 9 inches (which may be dependent on the sizes of containers to be accommodated) and a total height of, for example, about 1 inch to about 2 inches. In some examples, there may be an inner ring 24 for positioning the container, and the inner ring 24 may be, for example, offset about 0.25 to about 0.75 inches from the outer perimeter of the container ring 8 and may, for example, comprise 0.5 inches to about 1.75 inches of the total height of the container ring 8. In some examples, the magnet retainer 14 may have an outer diameter of, for example, about 2 inches to about 3 inches.

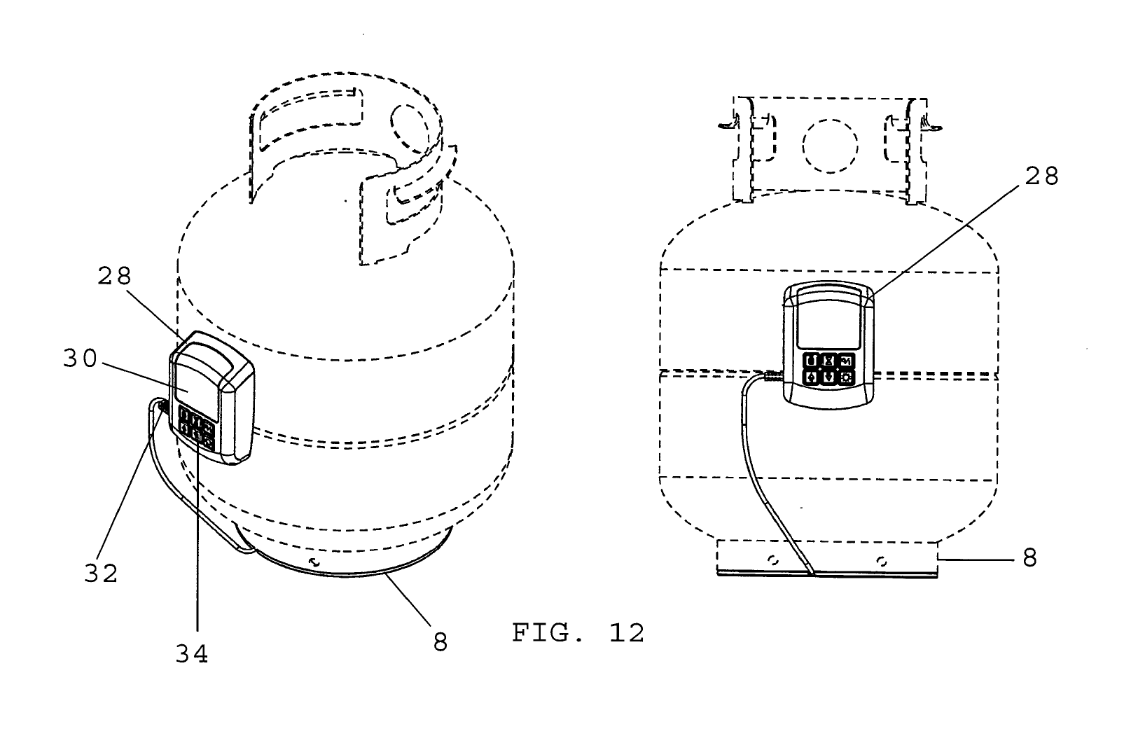

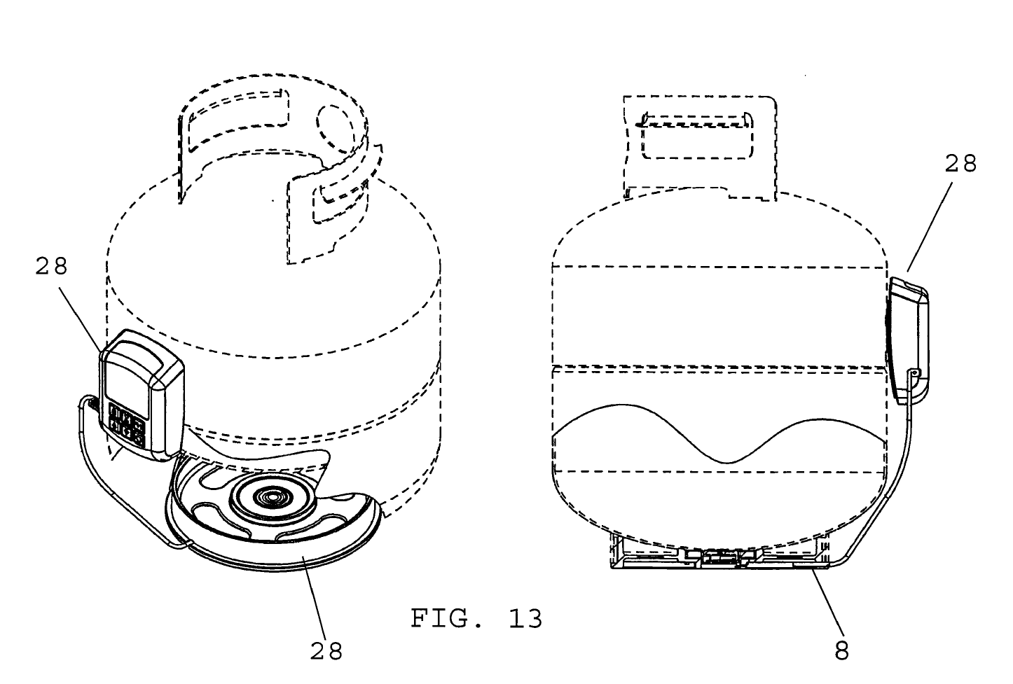

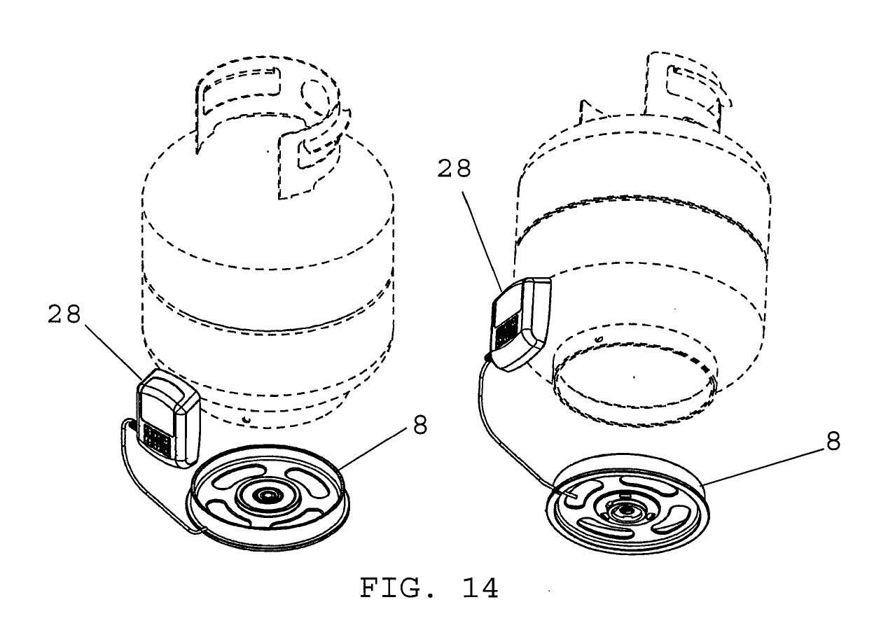

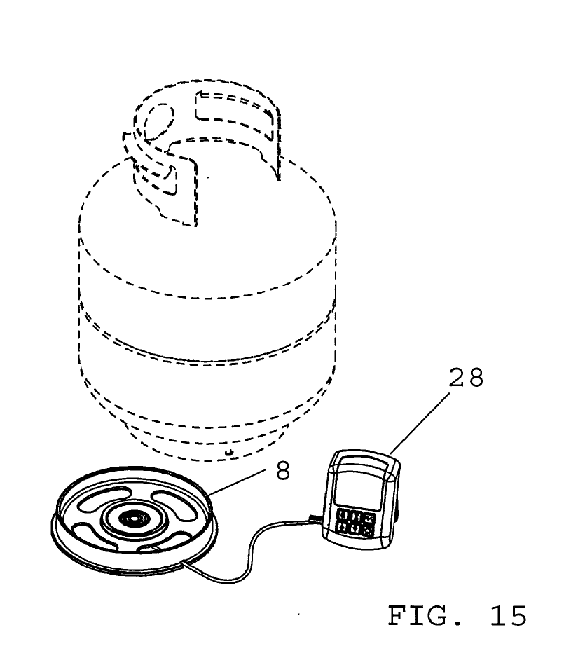

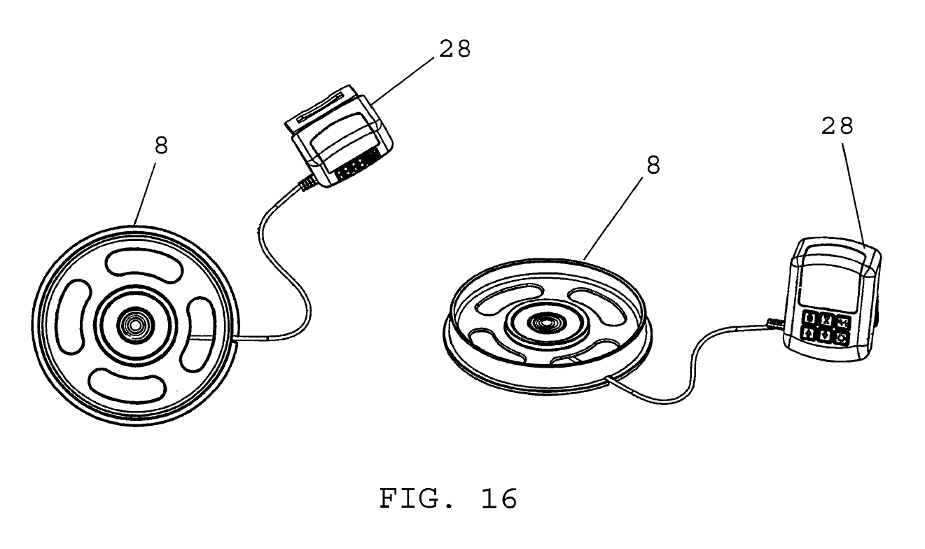

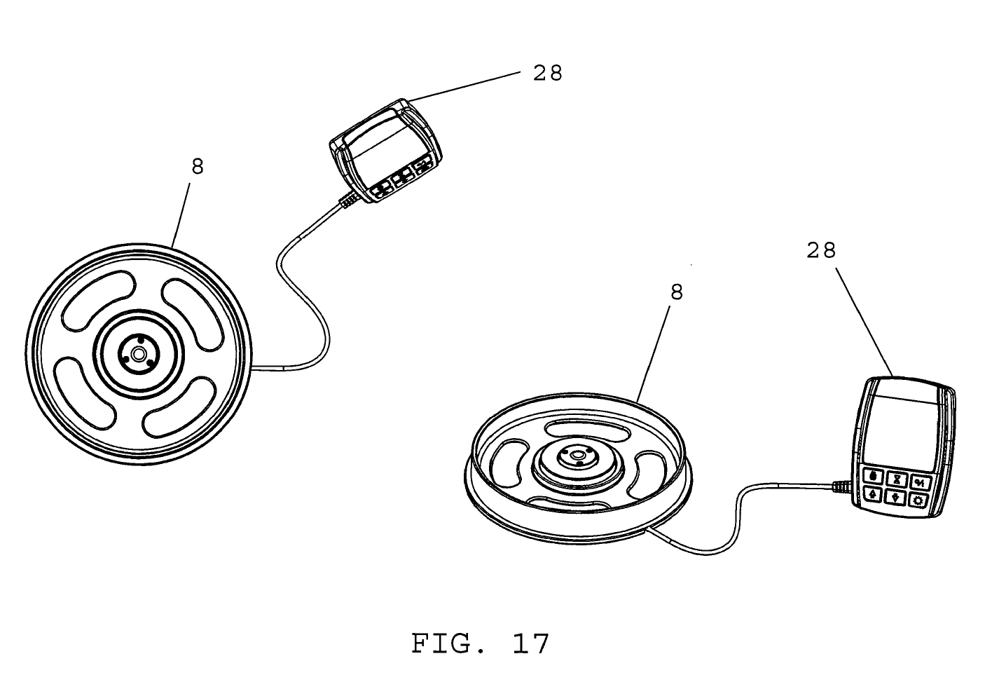

In an example embodiment, for example as shown in FIGS. 12-17, the container level sensor assembly may include a controller 28 which may include a display 30 and may further include one or more input ports 32 (e.g., for connecting to the level sensor and/or flow sensor).

In some examples, the controller 28 may include an input mechanism 34, such as a keypad, for example with 6 keys, e.g., I/O, Tank mode, Timer, Up, Down, Backlight. In some examples, the input mechanism 34 may be a touch sensing device (e.g., a touch-sensitive screen).

In some examples, the controller 28 may include a container switch. The container switch (e.g., mechanical or electrical) may allow for selecting and/or accommodating different container sizes, such as large, medium, small, or any other size. In some examples, the container switch may alternatively or additionally be provided on the container ring 8 (e.g., as a mechanical switch).

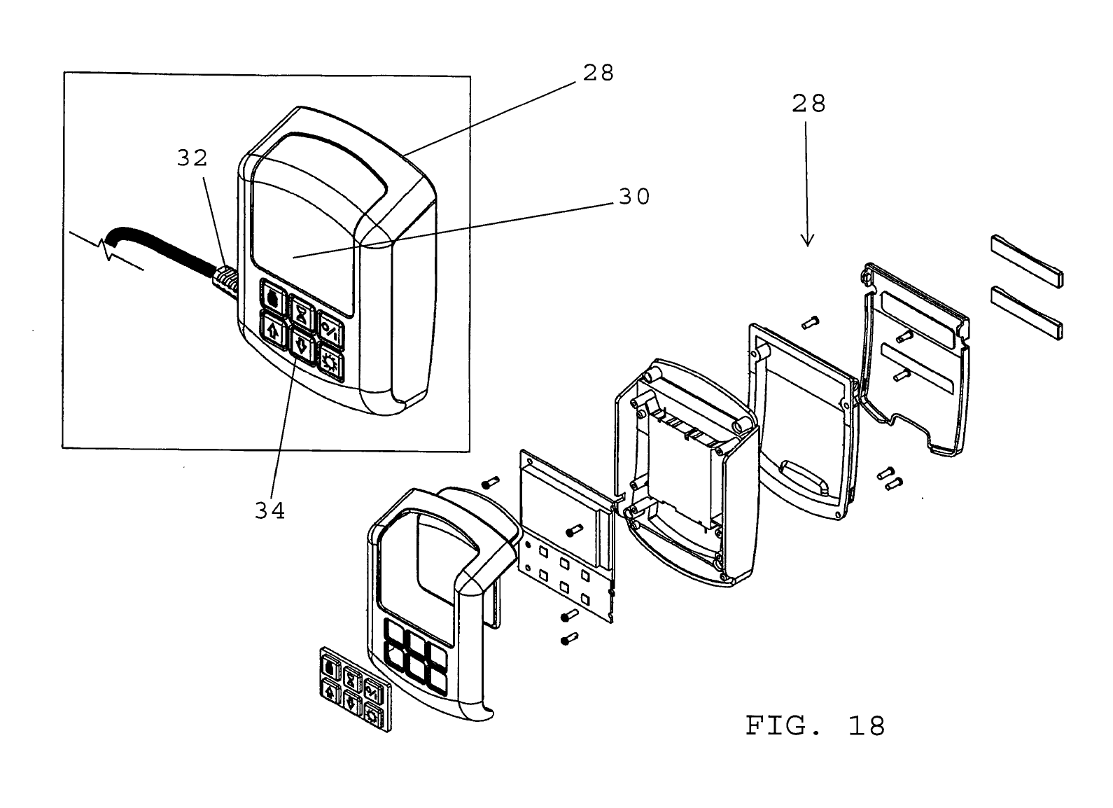

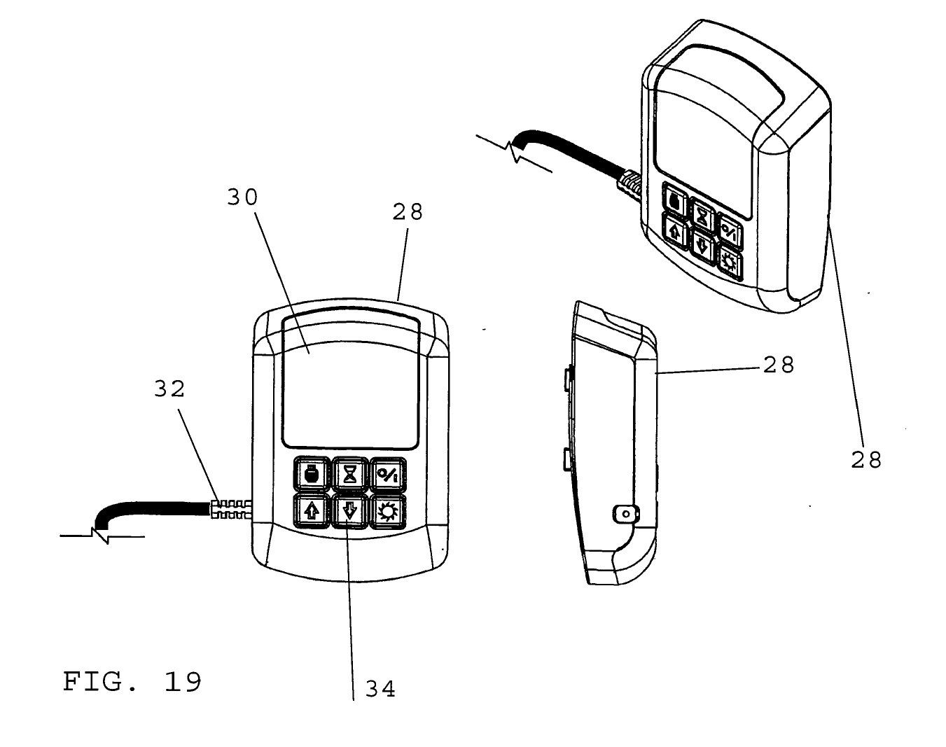

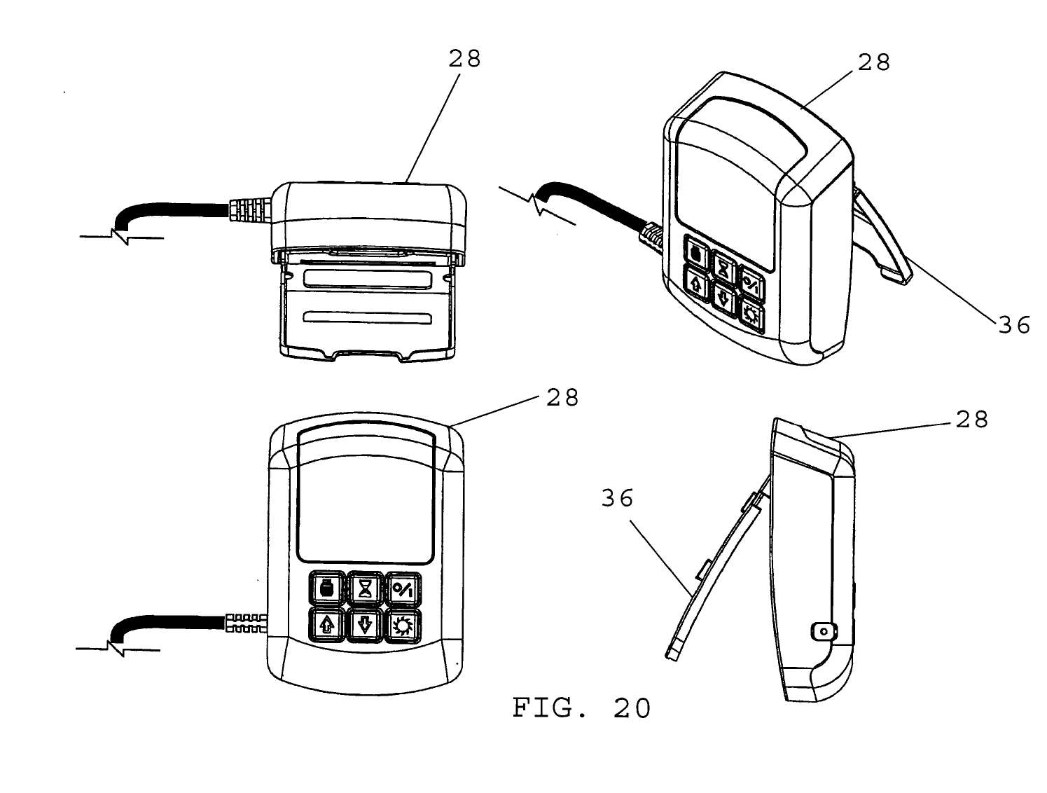

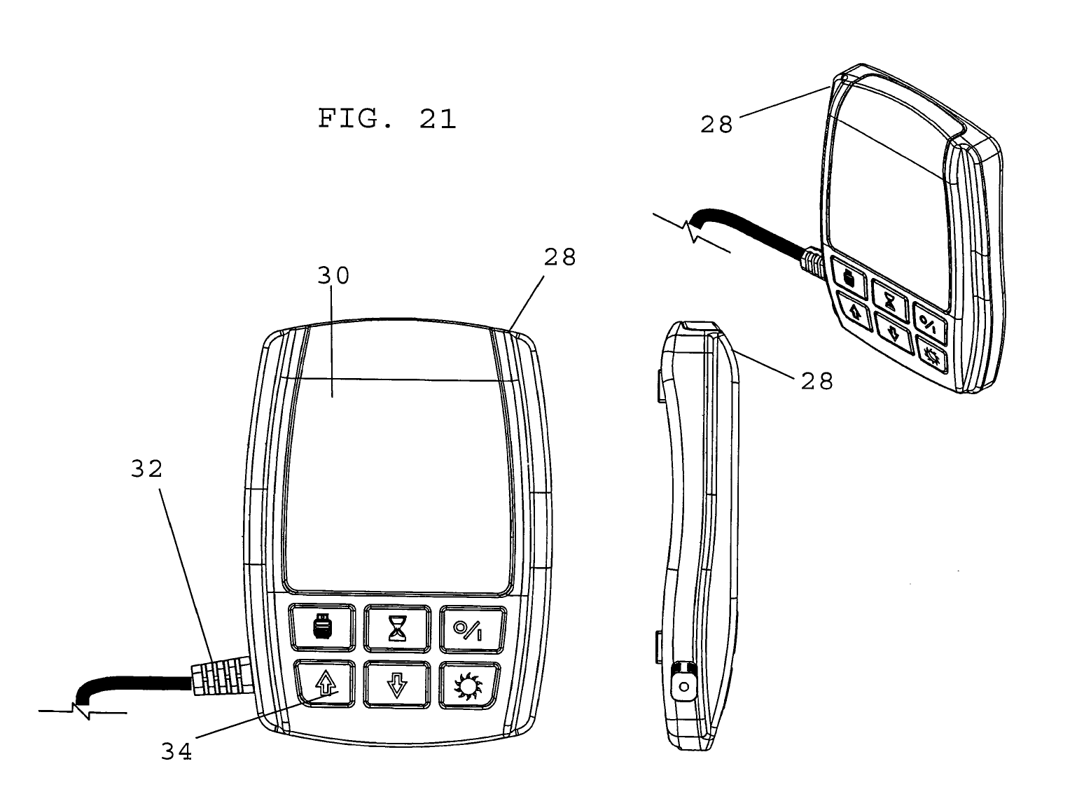

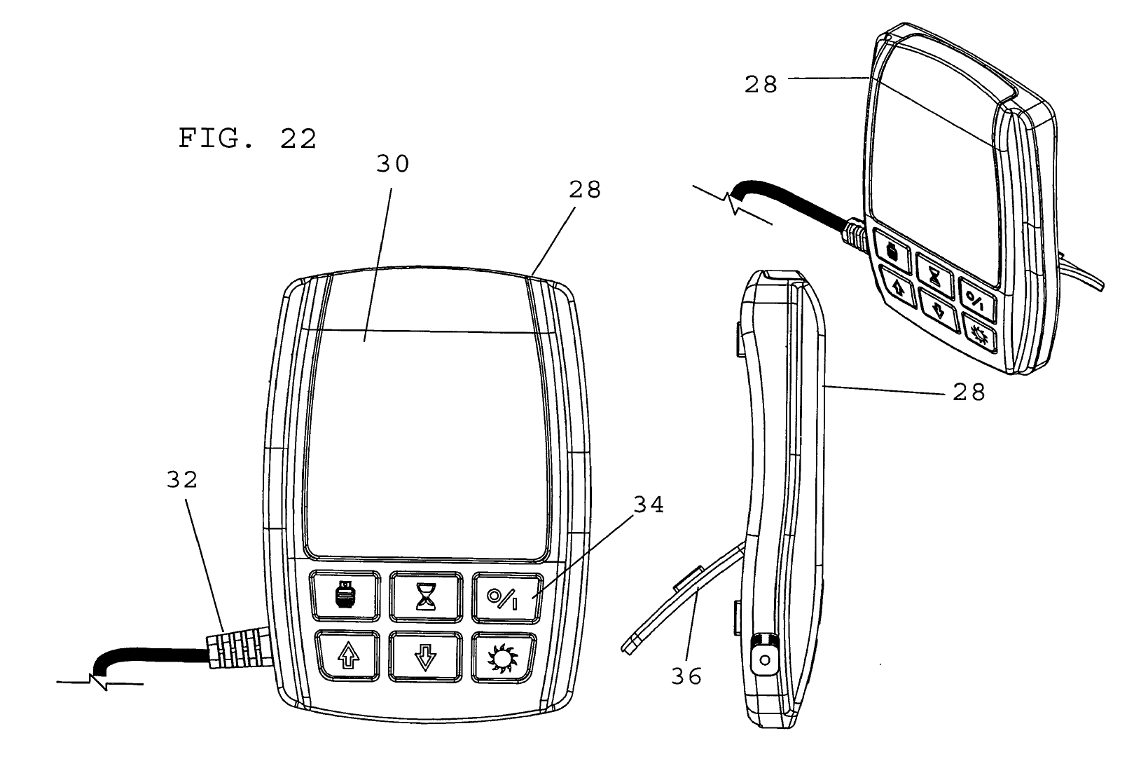

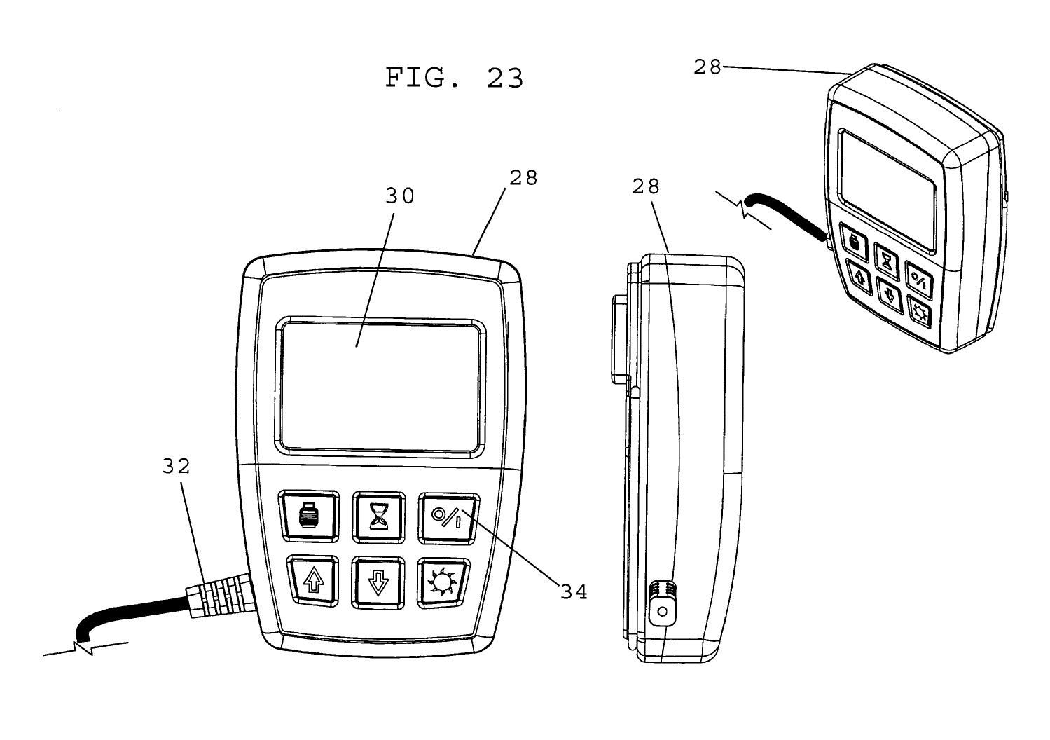

Reference is made to FIGS. 18-23. In the examples shown, the example controller 28 may include an input mechanism 34, such as electronic controls, with a display 30, such as an electronic screen, and may further include a processor (e.g., a printed circuit board). In some examples, the controller 28 may further include an amplifier, a speaker or other audio means for providing audio feedback. In some examples, the controller may further include a connector (e.g., a wire) to connect to and communicate with the level sensor 2. The controller 28 may also have a folding stand 36, for example for resting in a self-supporting upright position and/or may have a magnetic member on a back surface for attachment to a metallic surface, for example to the container (e.g., where the container is metallic, such as a gas tank of a barbeque). In some examples, the folding stand 36 may have one or more magnetic members, and may fold and/or snap into place securing the back stand arm. In some examples, the controller 28 may also include and/or receive power from a battery pack for power. In other examples, the controller 28 may have other power sources (e.g., a solar source, a thermal source, etc.) or may be connectable to an external power source (e.g., a power socket). In some examples, the display 30 may be a backlit display. The controller 28 may be designed to be contoured and ergonomic, for example similar to that of a cell phone, and may be easy to hold onto and/or stylish.

The controller 28 may be similar to the controller described in PCT/CA2007/002085, which publication is hereby incorporated by reference in its entirety. In some examples, the controller input mechanism 34 may include, for example, input buttons such as: Tank (e.g., for selecting the tank size or type), Timer (e.g., for setting a countdown timer), On/Off (e.g., for turning the controller 28 on/off), Up and Down (e.g., for increasing or decreasing a timer value), and Light (e.g., indicated by a sun logo, for turning on/off a backlight for the display 30). Where the controller 28 is to be used with a barbeque, the controller 28 may be configured to dock to the console of the barbeque, or may be integrated into the console of the barbeque. In both cases, the controller 28 may be detachable from the console of the barbeque.

The controller 28 may provide information, such as a timer with hours, minutes, and seconds (e.g., via the display 30). The timer may be used as a feature for cooking, for example, and a feedback feature (e.g., a buzzer, a speaker, lights, or other audio or visual feature) may indicate time complete.

The display 30 may provide information indicating time remaining of usage, as will be described below. The measured container level can be also shown in metric and/or imperial reading, indicating the actual measured container level of liquid in the container.

The container level sensor assembly may also include or cooperate with, for example, other sensors (not shown) such as a temperature probe (e.g., meat probe and/or meat thermometer similar to features described in PCT/CA2007/002085). In some examples, the temperature probe may communicate a sensed temperature wirelessly (e.g., using Bluetooth or other suitable technology) to the controller 28. In some examples, the temperature probe may communicate with the controller 28 via a wired connection to the input port 32. The temperature probe may be, for example, any suitable conventional temperature probe.

The controller 28 may be capable of processing signals from various sensors. For example, where the level sensor 2 is a sonar-based sensor, the controller 28 may be configured (e.g., with appropriate software instructions encoded in the processor) to process such signals in order to make sonar-based calculations. Similarly, where the level sensor 2 is a force or pressure-based sensor, the controller 28 may be configured to process such signals accordingly. The controller 28 may be configured (e.g., with appropriate software instructions encoded in the processor) additionally to process optional sensors such as, for example, temperature sensors.

In some examples, the level sensor 2 may communicate the measured container level to the controller wirelessly (e.g., using Bluetooth or other suitable technology), or via a wired connector 26 connected to the input port 32.

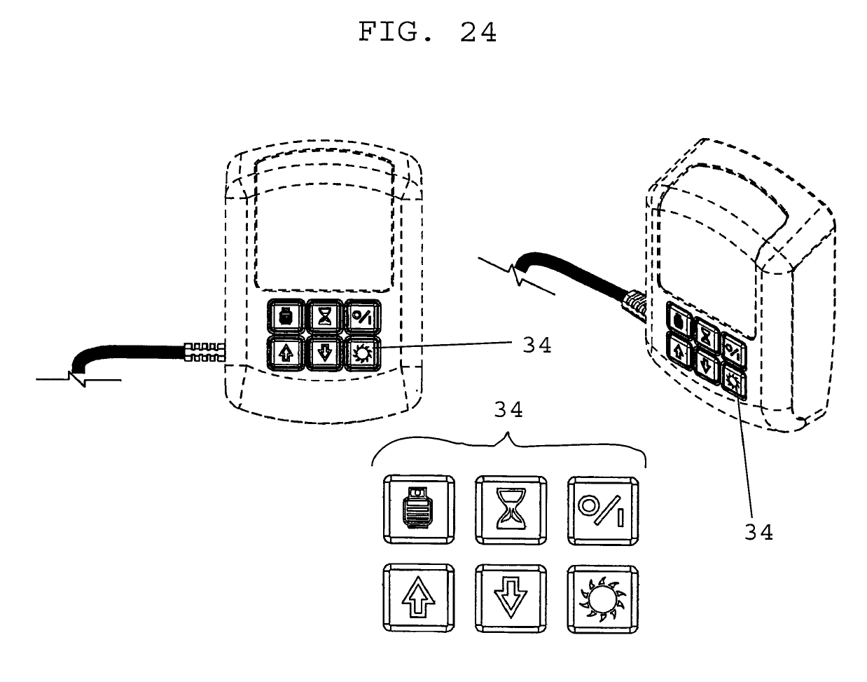

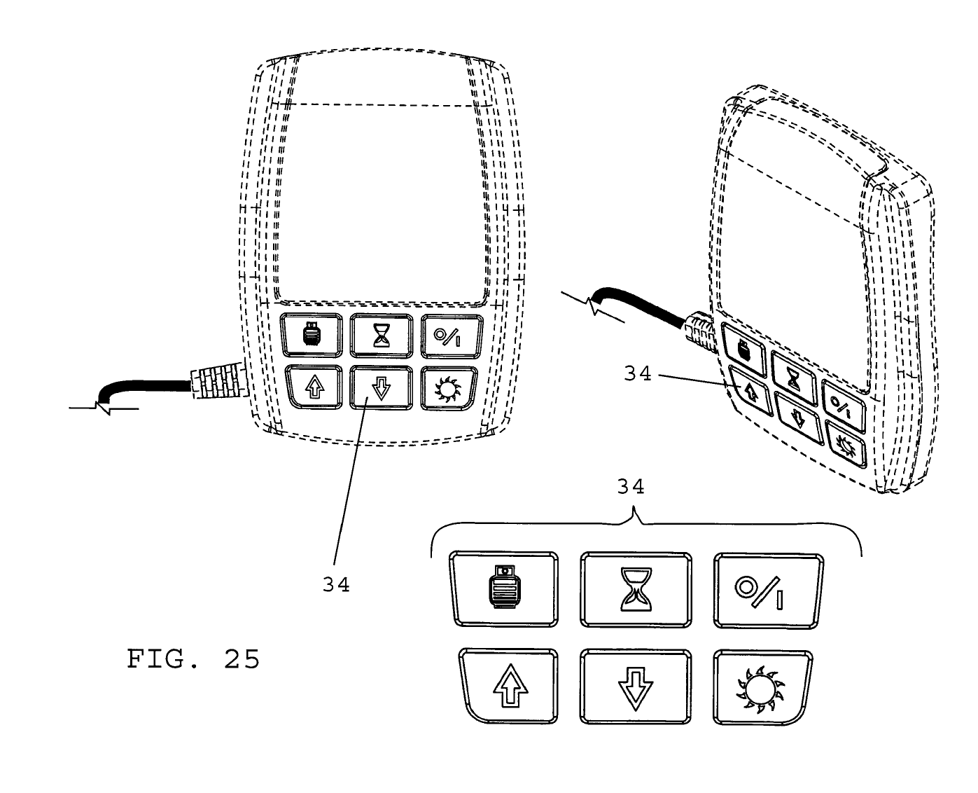

Reference is made to FIG. 24 and FIG. 25. In these examples, the input mechanism 34 for the controller 28 may include a keypad having one or more buttons. The button(s) on the controller 28 may be made of rubber, tack, membrane, or any other suitable material. Physical button(s) may be replaced with a touchscreen or any other suitable input mechanism. The input mechanisms 34 of FIG. 24 and FIG. 25 are shown as examples only, and variations may be possible, for example to accommodate other functions of the controller 28. Other input mechanisms 34 may be suitable including, for example, dials, levers, keypads, and combinations thereof.

Wired and wireless versions of the controller 28 may be possible. In the wired version, a wire, for example, may be long enough to reach from the level sensor 2 at the bottom of the container to the controller 28, which may be located at a side shelf height of grill. In a wireless version, the controller 28 may receive signals from the sensor 2, for example via short-range wireless communication. In some examples, communication between the level sensor 2 and the controller 28 may be selectively switched between wired and wireless communication. In a wired version, the controller wire may vary in length, for example to accommodate different barbeque designs. In a wireless version, the maximum wireless communication distance between the controller 28 and the sensor 2 may be any suitable distance, for example about 5 feet or more.

The controller 28 could be secured, for example to a barbeque assembly, by mounting onto a magnetic or metallic piece of the barbeque. For example, the controller 28 may mount directly to the container, for example using magnetic members on the back of the controller housing, as described above. In other examples, the controller 28 may be removably attached to the container by other fasteners, such as a strap, a hanger, a clip, Velcro, or tape (e.g., where the container is not metallic). In some examples, the controller 28 may be non-removably attached to the container.

In some examples, one or more components of the container sensor level assembly (e.g., controller housing and/or container ring 8) may be made of injection molded plastics or any other suitable material. In some examples, the magnetic member 10 may be any suitable material, and may be strong enough to maintain a good contact with the container bottom.

In some examples, the container may be only partially metallic and/or the container may be provided with metallic plates or additions, and the magnetic member 10 of the assembly and/or the magnetic backing of the controller 28 may be used with such metallic portions of the container.

In some examples, it may be possible and/or desirable to use the container ring 8 as an add-in to conventional basepans of existing barbeque grills. In some examples, the container ring 8 may be configured to be simply placed within conventional basepans. In other examples, the container ring 8 may be integrated into basepans of barbeques.

In some examples, the controller 28 may be configured with a processor capable of executing software or instructions for carrying out a method for determining the amount of liquid remaining in the container. In some examples, the controller 28 may include a memory having such instructions encoded thereon. An example set of instructions suitable for this purpose is now described.

For example, the processor in the controller 28 may receive (e.g., through wired or wireless communication) a signal from the level sensor 2 indicating the measured height of liquid (e.g., a liquid fuel) inside the container (i.e., the container level). This information from the level sensor 2 may be further processed by the controller 28 in order to calculate the height of liquid inside the container. This information may be directly conveyed to the user (e.g., via the display 30 on the controller 28). In some examples, the height of liquid may be converted to a weight of liquid, for example using a conversion table stored in the processor, which may also take into consideration the size and/or geometry of the container (e.g., a narrower or a wider container). From the converted weight of liquid, the processor may determine the amount of consumption time remaining. In some examples, the type of information presented may be selectable, for example using the input mechanism 34.

In some examples, a user may be provided with information about the weight (alternative to or in addition to volume) of liquid remaining or used. This may provide information which may be useful for indicating whether additional liquid should be obtained. In some examples, the controller 28 may automatically provide a warning (e.g., an audio signal or a visual signal) when the remaining liquid in the container is below a certain threshold.

The weight of remaining liquid may be calculated by the controller 28, for example, based on the measured height of liquid in the container. For example, the controller 28 may estimate the dimensions (e.g., diameter and shoulder radius) of the container (e.g., as indicated by the container switch) and multiply the cross-sectional area of the container with the measured height to determine or estimate the volume of liquid in the container. The volume may then be multiplied with the specific gravity of the liquid (e.g., the known specific gravity of a liquid fuel in the case of a barbeque) to determine an estimated weight of remaining liquid in the container. This calculation may or may not be adjusted for different cylinder designs and variations in temperature. In other examples, the weight of remaining liquid may be measured directly using, for example, a pressure sensor or a force sensor located beneath the container (e.g., where the level sensor 2 may be capable of measuring pressure or force, or using a pressure or force sensor in addition to the level sensor 2).

In some examples, the calculation of consumption time remaining may be based on the consumption rate of liquid from the container (e.g., as sensed by a flow sensor and/or based on the flame setting). In some examples, the consumption rate may be estimated or determined by the controller 28 based on a measured flow rate (e.g., using a flow sensor positioned at the container outlet). For example, if the measured flow rate changes (e.g., the flame is turned down in a barbeque, leading to a reduced fuel flow), the consumption rate may be updated to reflect an increased available consumption time for the lower flow rate.

In some examples, the consumption time remaining may be estimated or determined by the controller 28 based on the measured liquid level over time. For example, the liquid level within the container may be measured repeatedly at known time intervals (e.g., 30 seconds). The level difference between two measured liquid levels (e.g., between two consecutive readings, or over non-consecutive readings) may be determined as well as the time difference between the two measurements. The level difference may be then divided into the measured remaining liquid level and multiplied by the time difference to estimate the time remaining. This method may be based on an assumption of relatively steady consumption between the two measurements. In other examples, level differences and/or time differences may be determined for multiple pairs of level measurements, and the time remaining calculated may be based on the differences for each pair and the calculated results may be averaged.

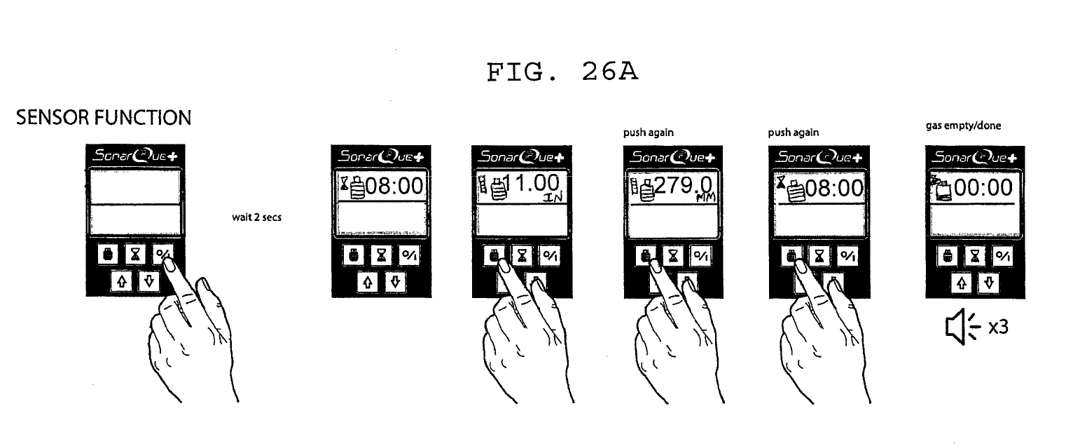

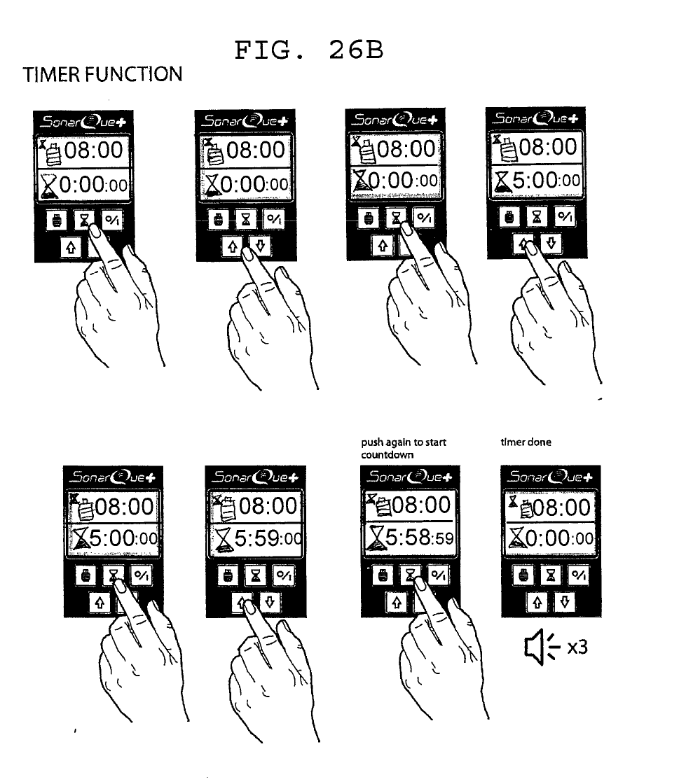

Reference is now made to FIG. 26A, illustrating an example operation of the container level sensor assembly.

When a power source (e.g., batteries) are connected for the first time the controller 28 may or may not automatically activate.

When the I/O or On/Off button is pressed for the first time the controller 28 may turn ON, as well as the display 30 (e.g., a backlight may turn on). The following operation may occur:

A container sensor (PALS) software module in the controller 28 may be activated. After a time delay (e.g., 2 seconds) or when the information is available the display 30 may display a small Clepsydra icon and may also display hours/minutes of remaining consumption time available in the container. This information may be also related to the size of the container (e.g., as selected by the position of a container switch).

The controller 28 may request and/or receive updated measurements from the level sensor 2 in order to update the displayed information. For example, the a container level display may be updated, for example up to 2 readings each minute for the next hour.

In some examples, if no other input is received (e.g., no buttons of the input mechanism 34 are pressed) for a time duration, such as after an hour, the display 30 may be turned off to conserve power, while the controller 28 may remain activated. Interaction with the controller 28 (e.g., via the input mechanism 34, such as for timer setup) may extend the display time.

Example interactions with the controller 28 using the input mechanism 34 are now described, with reference to the example input mechanisms 34 of FIGS. 24 and 25. These are examples only and are not intended to limit the input mechanism 34 or the functions possible. For example, other interactions may be suitable to accommodate other calculations or functions of the controller 28 (e.g., where remaining liquid may be indicated as a weight of remaining liquid, or where temperature information may also be provided, etc.).

Input using the Tank key may cycle through selections of different types of information about the remaining liquid in the container. For example:

A selection may switch the displayed information from Time mode (e.g., providing information about a remaining consumption time available) to inch mode (IN) (e.g., providing information about the height of the remaining liquid, in inches) and the small Ruler icon and IN icon may be activated. The display 30 may continue to display the amount of liquid (e.g., liquid fuel) left in terms of the height of remaining liquid in inches, for example, for the next hour.

Another selection may switch the displayed information from IN mode to millimetres mode (MM) (e.g., providing information about the height of the remaining liquid, in millimetres). The MM icon may be activated and the display 30 may continue to display the amount of liquid (e.g., liquid fuel) left in terms of the height of remaining liquid in millimetres, for example, for the next hour.

Another selection may switch the displayed information from MM mode to Time mode. The display 30 may continue to display the amount of liquid (e.g., liquid fuel) left in terms of the amount of remaining consumption time, for example, for the next hour.

Other selections using the input mechanisms 34 of FIGS. 24 and 25 may include, for example, setting a timer using a combination of the Timer key and the Up and Down keys.

The display 30 and controller 28 may be turned OFF and/or Timer setups may be cancelled at any time by selecting the I/O button.

Reference is now made to FIG. 26B, illustrating another example operation of the container level sensor assembly.

In this example, the controller 28 may provide a count down timer (e.g., in response to selection of the Timer key), which may be useful, for example, to assist in timing cooking for a barbeque.

If the Time key is selected for the first time a large Clepsydra icon may be activated and timer's digits may display 00:00:oo. To set the timer, the Timer key may be selected and the Up and Down keys may be used to set the countdown time.

A selection of the Timer key may switch the controller 28 to Hours setup mode. The display 30 may indicate Hours setup mode has been activated, for example, by cycling on-off the hours digits. The Up and Down keys may be used to set the hours. There may be a maximum to the number of hours that may be selected (e.g., max 5 hours).

Another selection of the Timer key may switch the controller 28 to Minutes setup mode. The display 30 may indicate Minutes setup mode has been activated, for example, by cycling on-off the minutes digits. The Up and Down keys may be used to set the minutes.

There may be a maximum to the number of minutes that may be selected (e.g., max 59 minutes).

Another selection of the Timer key may switch the controller 28 to a count down mode, which may begin a countdown timer based on the time selected in the Hours and/or Minutes setup mode(s).

After the countdown time expires the controller 28 may activate a signal, such as a sound alarm (e.g., buzz three times).

The display 30 may continue to display information (e.g., information about the remaining liquid), for example for the next 15 minutes, after the Timer's time expires and then may automatically switch off.

To conserve power (e.g., where the controller 28 is battery powered), the display 30 (e.g., a display backlight) may be turned off, for example after each 15 minutes. Backlight can be turned ON by selection of the Light key, for example, for another 15 minutes.

Other variations of the controller 28 may be possible, including variations to the input mechanism 34 and/or the functions described above.

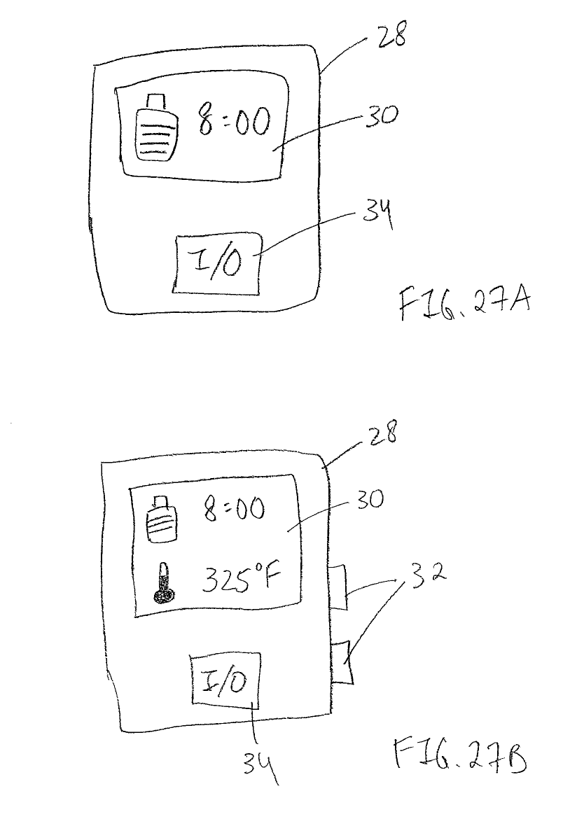

For example, the controller 28 may be relatively simple, and provide information only in one format (e.g., only provide information on the remaining consumption time and/or only provide information on the height of the remaining liquid). An example is shown in FIG. 27A. In this example, the controller 28 may include a relatively simple input mechanism 34, such as a single button (e.g., to turn the controller 28 ON/OFF), and a display 30 providing simplified information (in this example, information about the remaining consumption time, along with a simple graphic indicating the approximate level of remaining liquid in the container).

In some examples, the controller 28 may have one or more input ports 32 for communication with sensors (e.g., level sensor 2, temperature sensor and/or pressure sensor, among others). Information from such sensors may be provided, for example via display 30. An example is shown in FIG. 27B. In this example, the controller 28 may include a relatively simple input mechanism 34, such as a single button (e.g., to turn the controller 28 ON/OFF), and a display 30 providing information, in this example, about the remaining consumption time and the height of remaining liquid, as well as information from one or more sensors, in this case a temperature sensor (e.g., a meat probe) that may be connected (not shown) via an input port 32. In some examples, the input mechanism 34 may provide the ability to select between displays of information from different sensors (e.g., switch between a temperature sensor and a level sensor) and/or select between how the information is displayed (e.g., between Fahrenheit and Celsius). The input mechanism 34 may include any combination of the buttons or selectors described in this disclosure, for example to suit different functionalities of the controller 28.

In some examples, in addition to or alternative to the input port(s) 32, the controller 28 may communication with one or more sensors wirelessly (e.g., the controller 28 and the sensor(s) may be equipped with wireless communication components). In some examples, the controller 28 may be switchable between a wired and a wireless communication mode.

In some examples, the controller 28 may have a width of, for example, about 2.5 to about 3.5 inches, for example about 3.2 inches; the controller 28 may have a depth of, for example, about 1 to about 2 inches, for example about 1.3 inches; and the controller 28 may have a height of, for example, about 4 to about 5 inches, for example about 4.6 inches. Although these dimensions are provided for the purpose of illustration, they are not intended to be limiting, and other dimensions are possible.

The embodiments of the present disclosure described above are intended to be examples only. Alterations, modifications and variations to the disclosure may be made without departing from the intended scope of the present disclosure. In particular, selected features from one or more of the above-described embodiments may be combined to create alternative embodiments not explicitly described. All values and sub-ranges within disclosed ranges are also disclosed. The subject matter described herein intends to cover and embrace all suitable changes in technology. All references mentioned are hereby incorporated by reference in their entirety.

1. A container level sensor assembly comprising:
a level sensor for measuring a level of a liquid in a container;
a contact layer between a sensing surface of the level sensor and the container for maintaining a close contact between the level sensor and the container;
a biasing member for biasing the level sensor towards the container;
a container ring configured to accommodate the level sensor, the container ring also being configured to support a base of the container;
the container ring having a magnetic member for bringing the container ring into close contact with the base of the container;
a controller including a processor for receiving measurement data from the level sensor and determining a remaining availability of liquid in the container based on the measured level of the liquid; and
a display device for displaying the determined remaining availability of liquid in the container.

2. The container level sensor assembly of claim 1 wherein the magnetic member comprises one or more magnets configured about the level sensor.

3. The container level sensor assembly of claim 2 wherein the magnetic member comprises at least three individual magnets configured in a ring formation about the level sensor.

4. A container level sensor assembly comprising:
a level sensor for measuring a level of a liquid in a container;
a contact layer between a sensing surface of the level sensor and the container for maintaining a close contact between the level sensor and the container;
a biasing member for biasing the level sensor towards the container;
a retainer configured to accommodate the level sensor; and
the retainer having a magnetic member for bringing the level sensor into close contact with the container.

5. The container level sensor assembly of claim 4 wherein the magnetic member comprises one or more magnets configured about the level sensor.

6. The container level sensor assembly of claim 5 wherein the magnetic member comprises at least three individual magnets configured in a ring formation about the level sensor.

7. The container level sensor assembly of claim 4 wherein the level sensor comprises a connector for coupling the level sensor to a controller for receiving measurement data from the level sensor and determining a remaining availability of liquid in the container based on the measured level of the liquid.

8. The container level sensor assembly of claim 4 wherein the retainer is provided on a container ring for supporting a base of the container.

9. The container level sensor assembly of claim 4 further comprising:
a controller including a processor for determining a remaining availability of liquid in the container based on the measured level of the liquid; and
a display device for displaying the determined remaining availability of liquid in the container.

10. A container level sensor assembly comprising:
a level sensor for measuring a level of a liquid in a container;
a retainer configured to accommodate the level sensor;
the retainer having a magnetic member for bringing the level sensor into close contact with the container;
a controller including a processor for receiving measurement data from the level sensor and determining a remaining availability of liquid in the container based on the measured level of the liquid; and
a display device for displaying the determined remaining availability of liquid in the container.

11. The container level sensor assembly of claim 10 wherein the level sensor is biased towards the container.

12. The container level sensor assembly of claim 10 wherein the level sensor comprises a contact layer for maintaining a close contact between the container and the level sensor.

13. The container level sensor assembly of claim 10 wherein the retainer is provided on a container ring configured to support a base of the container.

14. The container level sensor assembly of claim 10 wherein the magnetic member comprises at least one magnet configured about the level sensor.

15. The container level sensor assembly of claim 14 wherein there is a plurality of magnets configured about the level sensor, the magnets being configured to bring the level sensor into close contact with the container.

16. The container level sensor assembly of claim 15 wherein the magnetic member comprises at least three individual magnets configured in a ring formation about the level sensor.

17. The container level sensor assembly of claim 10 wherein the remaining availability of liquid is determined as at least one of: a height level of remaining liquid in the container, a weight of remaining liquid in the container, and a remaining consumption time of remaining liquid in the container.

18. The container level sensor assembly of claim 10 wherein the level sensor measures the level of the liquid using sonar-based calculations.

19. The container level sensor assembly of claim 10 wherein the controller is further configured to receive information from at least one of: a temperature sensor, a flow sensor and a pressure sensor.

20. The container level sensor assembly of claim 19 wherein the remaining availability of liquid is determined as a remaining consumption time of remaining liquid in the container, based on a measured flow rate of liquid from the container.
